(19) United States
(12) Patent Application Publication
(10) Pub. No.: US 2015/0296769 A1
(43) Pub. Date: Oct. 22, 2015

(54) CLIMBING TREE STAND WITH MOBILITY AND SAFETY STRAP

(71) Applicant: Todd Franklin Rebone, Muskegon, MI (US)

(72) Inventor: Todd Franklin Rebone, Muskegon, MI (US)

(21) Appl. No.: 14/684,696

(22) Filed: Apr. 13, 2015

Related U.S. Application Data
(60) Provisional application No. 61/982,670, filed on Apr. 22, 2014.

(51) Int. Cl. A01M 31/02

(52) U.S. Cl. CPC A01M 31/02

(57) ABSTRACT

A bootstrap system releasably positively connects a hunter's boot to a base platform of a climbing tree stand in a manner giving control when raising (or lowering) the base platform as part of climbing (or descending) a tree. The system includes an upper strapping component comprising a nylon strap with buckle and strap lock attached to the hunter's boot shaft, and a lower strapping component having similar components and that is releasably attached to the upper strapping component and to the base platform. The bootstrap system can be used in combination with known toe-restraint devices on the base platform of a climbing tree stands. The bootstrap system is adjustable for any boot size, and for use with a wide variety of climbing tree stands.

This application claims benefit under 35 USC section 119(e) of a U.S. Provisional Application Ser. No. 61/982,670, filed Apr. 22, 2014, entitled BOOTSTRAP TO KEEP YOUR HEALS DOWN USING A CLIMBING TREE STAND, the entire contents of which are incorporated herein by reference.

### BACKGROUND OF THE INVENTION

The present invention is a bootstrap system that provides a hunter increased mobility and safety in hoisting and lowering a climbing tree stand. The system is adjustable to accommodate different boot sizes, and also adjustable and flexible in its attachment such that it can be used on most climbing tree stands

Climbing tree stands are tree stands that offer a combination of portability and flexibility compared with many other types of stands. Most climbing tree stands today have a top section (i.e. seat) and a bottom section (i.e. footrest platform) that alternatingly bite into the tree and bear weight as the other section is lifted. For example, the bottom section will have some type of foot support that can be engaged by a front of the hunter's boot to assist in the lifting of the bottom section while the hunter leans on the top section. Once the bottom section is lifted, it locks in a cantilevered manner onto the tree by loading it with the hunter's weight. With the bottom section locked and supporting the hunter's weight, the top section is freed and raised to a new position (using the hunter's legs to lift), where it is then locked in place by loading it with body weight. The process of alternatingly lifting the bottom section and top section are repeated to climb the tree (or to descend the tree).

A problem is that commercially available climbing tree stands only provide some type of toe clip, frame integrated toe constraint, or toe strap (hereafter referred to as “toe restraints”) to constrain the hunter's boot to the bottom section of the climbing tree stand. All of these options require the hunter to lift with the toe portion of the foot while making sure that his foot remains biased forwardly sufficiently to remain engaged with the toe constraint. None of these options physically connect the hunter's feet or boot to the base platform of the climbing tree stand. As a result, the hunter may lose connection to the bottom section, allowing it to slip sideways or fall. This is frustrating and can be unnerving when high up in a tree, since the bottom section will “dangle” while the hunter attempts to re-engage his boot with the toe restraint on the bottom section. In a worst scenario, the bottom section may slip downward away from the hunter since there is no cantilevering weight on the bottom section to cause it to bite into a tree and stop its falling descent.

There is an unfulfilled need to improve climbing tree stands to eliminate this problem of disconnection from toe restraints, and to do so in a way that is inexpensive and that provides increased mobility and safety for the hunter when hoisting and lowering a climbing tree stand.

### SUMMARY OF THE INVENTION

The present bootstrap system innovation is inexpensive, simple to use, and flexible for use with different climbing tree stands, while providing increased mobility and safety when using the tree climbing stand. Increased mobility and safety is achieved because the present bootstrap system physically provides a positive connection between the hunter's heels and the base platform on the climbing tree stand. Notably, the present bootstrap system is so flexible and adaptable that it can be used with most existing climbing tree stands, regardless of their particular existing toe restraints and regardless of the hunter's foot size and boot design.

In one aspect of the present invention, an apparatus includes a climbing tree stand having an seat-forming upper section and a base platform section that can be used to alternatingly bear weight as the other of the sections is lifted while climbing or descending a tree; and a bootstrap system having an upper strapping component adapted to be positively secured to a hunter's boot shaft and having a lower strapping component attached to the base platform section and to the upper strapping component so that the hunter is tethered to the base platform section to maintain control of an angle and height of the lower section when using the hunter's boots to lift or lower the base platform section on the tree.

In another aspect of the present invention, a method comprises providing a climbing tree stand including an seat-forming upper section and a base platform section that can be used to alternatingly bear weight as the other of the sections is lifted while climbing or descending a tree; securing the base platform section to a hunter's boots by using an upper strapping component positively secured to a hunter's boot shaft and by using a lower strapping component attached to the base platform section and to the upper strapping component; and climbing a tree by alternatingly bearing weight on the upper section and base platform section while the other section is lifted, with the hunter being tethered to the base platform section to continuously maintain control of an angle and height of the base platform section when using the hunter's boots to lift or lower the base platform section on the tree.

An object of the present invention is to provide a bootstrap system that releasably connects a hunter's boots to base platform (footrest) of a tree climbing stand, allowing the hunter more control in lifting, lowering, and positing of the bottom section (footrest platform).

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of a climbing tree stand having the present innovative bootstrap system attached to its bottom section.

FIGS. 2-4 are side views of a climbing tree stand with the hunter faces in a first low position on a tree (FIG. 2), the hunter lifting the bottom section (FIG. 3), and then lifting the top section (seat section) (FIG. 4).

FIG. 5 is an enlarged side view of the hunter's boot and the present bootstrap system of FIG. 1.

FIG. 6 is an exploded view showing the present bootstrap system with upper and lower portions from FIG. 5.

FIG. 7 is a side view showing the present bootstrap invention combined with a toe-engaging support on a climbing tree stand.

FIGS. 8-9 are side views of a prior art climbing tree stand, including FIG. 8 showing a bottom section (i.e. footrest) where the boot engages a toe restraint, but also FIG. 9 where the hunter's boots tend to easily fall out of the toe restraint when lifted.

### DETAILED DESCRIPTION OF PREFERRED EMBODIMENT

The present innovative bootstrap system 1 releasably connects hunter's boots to a footrest platform of a climbing tree stand in a manner giving control when raising (or lowering) the tree stand's base platform, such as when climbing/ascending (or descending) a tree. Each bootstrap system 1 includes a first main component (called an “upper strapping component” herein) comprising a nylon strap with buckle and strap lock for attachment to the hunter's boot shaft (i.e. hunter's lower leg and ankle area), and a second main component (called a lower strapping component” herein) coupled to the first main component and designed for attachment to the base platform (also called “lower section” or “footrest platform” herein). The upper and lower strapping components are releasably interconnected, allowing the hunter to separate from the base platform after climbing to a desired height or when moving on the lower section.

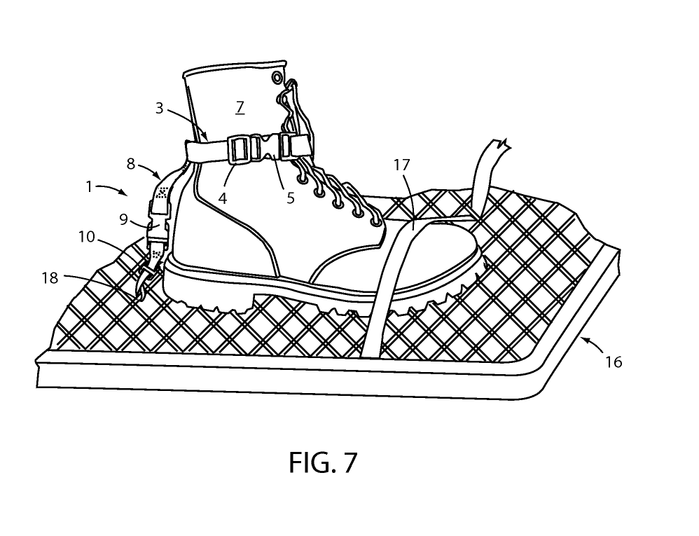

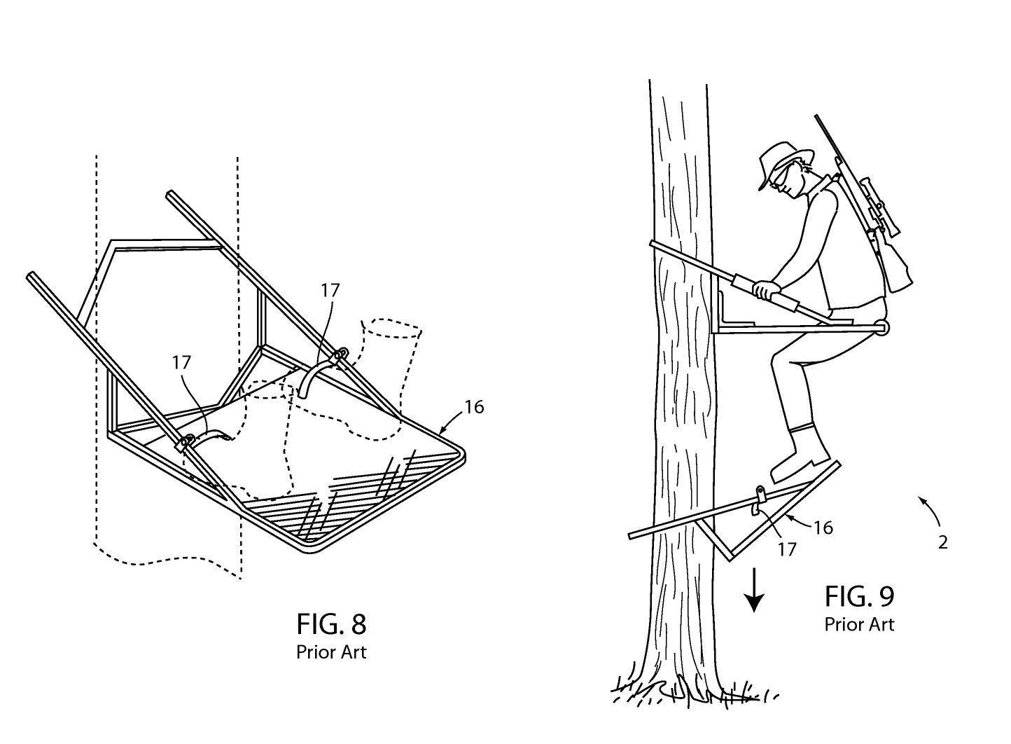

The bootstrap system 1 can be used with any toe-restraint device (see FIG. 7, such as a toe-restraint device already on the base platform). Alternatively, the bootstrap system 1 can be used to attach a boot at both front and rear locations if desired, or a single system 1 can be used alone if desired. The bootstrap system 1 is adjustable for any boot size, and for use with a wide variety of climbing tree stands. When used in combination with a toe restraint, the lower strapping component is preferably attached to the base platform 16 at a location adjacent a heel of the boot where it is spaced from the toe restraint, slightly rearward of a center of gravity of the base platform. In this arrangement, the lower strapping component holds the hunter's boot in the toe restraint. It also causes the lower strapping component and the toe restraint to work together to carry weight in a balanced manner when lifting the base platform 16. With both boots attached to the base platform 16, the hunter can control fore-aft and side-to-side angles of the base platform 16 as it is raised or lowered, which can help considerably when climbing some tree trunk shapes. The lower strapping component is preferably attached to the base platform 16 in a position that is near or rearward of a center of mass on the base platform 16.

The present bootstrap system 1 requires a onetime setup that pairs the hunter and the base platform 16 of the climbing tree stand. The hunter adjusts individually the upper strapping component (also called “upper portion”) of each bootstrap system to fit the boot shafts of the hunter's boots. The lower strapping component (also called “base-platform-connection section” herein) of strapping which includes a buckle and strap lock is free to move around the loop that is now attached the hunter's boot shaft. The hunter positions the lower strapping component that is looped over on the boot shaft section so that it extends downward and in line with the heel of the boot. The hunter completes this adjustment for both boots. The hunter then stands on the platform of the climbing tree stand and in a position suitable for hoisting or lowering the platform. It is at this position that the lower sections of straps that are aligned with the heel are attached to the base platform using the strap and strap lock. The end of the strap of the lower strapping component has a stitched loop (or has a strap length adjuster component) that when used with the strap and strap lock prevents the strapping from slipping when in use during hoisting or lowering the base platform of the climbing tree stand.

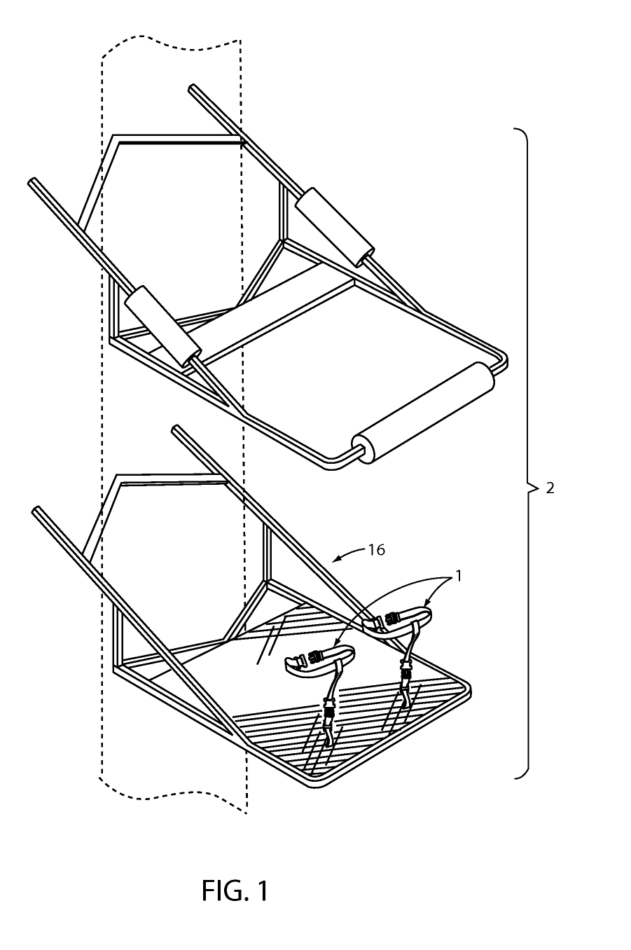

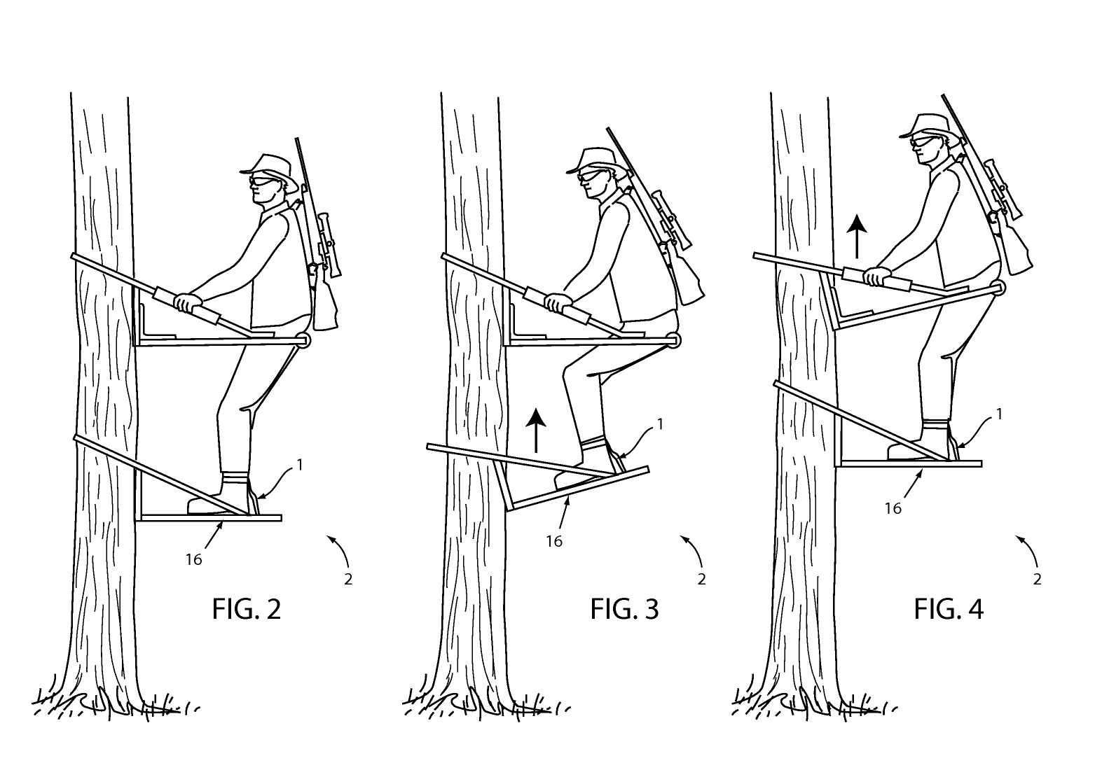

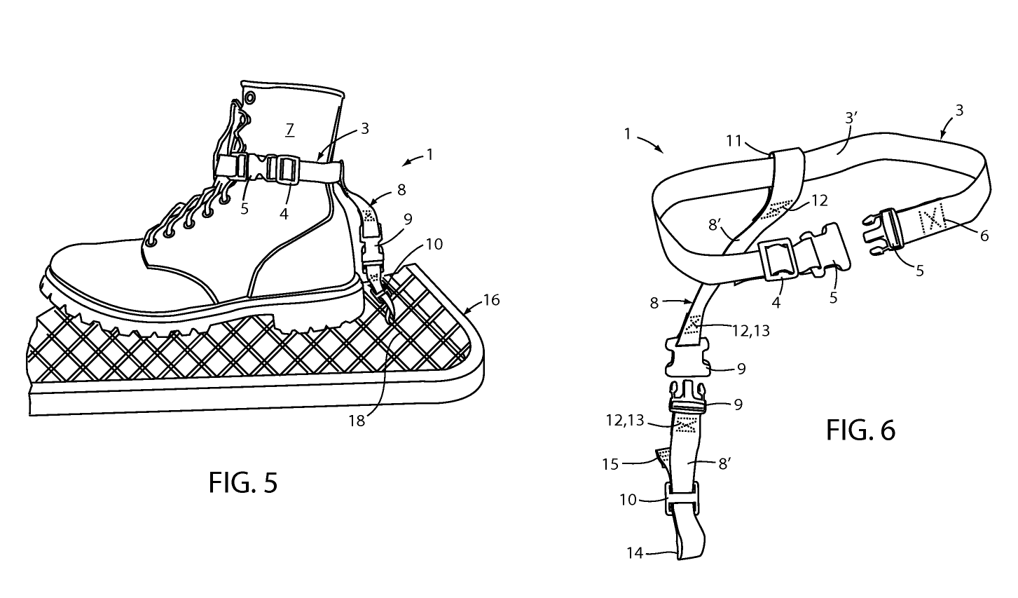

Referring now specifically to the drawings and the illustrated embodiments depicted therein, a bootstrap system 1 (FIGS. 5-6) is provided that, when used by a hunter and with a base platform 2 of a climbing tree stand 2 (FIGS. 1-3), provides increased personal safety and mobility when hoisting (climbing) and lowering the tree stand 2 on a tree trunk. The tree stand 2 (FIG. 2) includes a top section (also called a “seat” or “body resting platform” herein) and base platform 16 (also called a “footrest platform” or “bottom section” herein), each having a way of engaging a tree (such as a tree-hugging belt and/or tree-engaging teeth) so that they can alternatingly be used to lock onto the tree while the other is lifted in order to climb a tree. (See FIGS. 2-4.)

The illustrated bootstrap system 1 (FIG. 6) is substantially a two component strapping system. The upper strapping component 3 of the bootstrap system 1 is constructed of a nylon strap 3′, a buckle 5 and a strap lock 4. The one end of the buckle 5 is attached to the nylon strap 3′ by looping the nylon and stitching 6 it to itself. The strap lock 4 is used with one of the buckle 5 ends and used with excess strapping when the upper strap system is adjusted to fit the hunter's boot shaft 7 (FIG. 5). The lower strapping component 8 of the bootstrap system is constructed of nylon strap 8′, a buckle 9 and a strap lock 10. The lower strapping component 8 attaches to the upper strapping component 3 with a loop 11 created from the nylon strap 8′ of the lower strapping component 8. Stitching 12 is used to complete the loop 11.

The buckle 9 and strap lock 10 can be attached in several different ways, The illustrated buckle 9 and strap lock 10 are attached to the nylon strapping using a stitched 12 and 13 loop configuration. An additional loop 14 is positioned at the end of the lower strapping component 8 and is comprised of a strap lock 10 and a stitched end 15 of the nylon strap. The stitched end 15 is configured to allow the strap 8′ to be extended around available structure 18 on the base platform 16 and back into the strap lock 10, but when the strap 8′ is tensioned, causes the strap lock 10 to bite and prevent the loop 14 from disassembling from the strap lock 10. It is noted that the straps 3′, 8′, strap locks 4, 10, buckles 5, 9, stitching, and related components shown in the FIGS. 5-6 are commercially available and are of the type often used in outdoor backpacking and outdoor equipment, such that a detailed description of them herein is not required for an understanding by persons skilled in the art of outdoor activities and in particular in the art of climbing tree stands. By the present arrangement, the bootstrap system 1 positively retains and anchors (“tethers”) the base platform 16 to the hunter so that control of the base platform 16 cannot be lost. In particular, by using two bootstrap systems 1, one on each boot, the upper strapping component positively secures the base platform 16 to the hunter's boot shaft(s), tethering the base platform 16 to the hunter in a way allowing the hunter to maintain control of a fore-aft angle and of a lateral angle and of a height of the base platform 16 while allowing the hunter to lift or lower their boots to lift or lower the base platform 16 on the tree.

The present bootstrap system 1 requires a onetime setup and adjustment to tailor usage between the hunter and the base platform 16 (FIG. 5) of a climbing tree stand 2. The hunter initially adjusts the upper strapping 3 component to fit the hunter's boot shaft 7. The hunter stands positioned on the base platform 16 of the climbing tree stand 2 in a position compatible with hoisting or lowering the climbing tree stand 2 (FIG. 2). The hunter's position can incorporate usage of the toe supports 17 that are commonly supplied or included in the design of known climbing tree stands. The types of toe supports 17 (also called “toe restraints” herein) can vary by manufacturer—such as a structure built into the frame of the climbing tree stand, or an attachment to the frame, or a simple length of nylon strapping a fixed to the base platform.

When the hunter is positioned in the appropriate position to the hoist or lower the climbing tree stand, the location of the hunter's heel will identify the location on the base platform 16 where the lower strapping component 8 of the bootstrap system 1 is attached. The lower strapping component 8 is attached to the base platform 16 by disassembling the loop 14 by removing the nylon strapping from the strap lock 10. The loose end of what was the loop is then fed through the available structure 18 (FIG. 5) on the base platform 16 and reconfigured into a loop using the strap lock 10. FIGS. 2-5 show the bootstrap system 1 in a fully functional state where the upper strapping component 3 is attached to the hunter's boot shaft 7 and the lower strapping component 8 is attached to both the upper strapping component 3 and the base platform 16 of the climbing tree stand. This configuration when combined with the provided toe supports 18 of the climbing tree stand 2 provides the hunter with increased safety and mobility when hoisting or lowering the climbing tree stand 2, since control of the base platform 16 cannot be lost. The increase safety for the hunter is achieved by the bootstrap system 1 providing a positive (or “hard”) connection point between the hunter and the base platform 16. Once the hunter has completed the task of hoisting or lowering the climbing tree stand 2 the bootstrap system can be disengaged by releasing the buckle 9 on the lower strapping component 8. The lower strapping component 8 buckles 9 are the single point connection that connects the hunter to the base platform 16 of the climbing tree stand 2 and this single point of connection simplifies the usage of the bootstrap system 1.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. An apparatus comprising:
a climbing tree stand including a seat-forming upper section and a base platform section that can be used to alternatingly bear weight as the other of the sections is lifted while climbing or descending a tree; and
a bootstrap system having an upper component adapted to be positively secured to a hunter's boot shaft and having a lower component attached to the base platform section and to the upper component so that the hunter is tethered to the base platform section to maintain control of an angle and height of the lower section when using the hunter's boots to lift or lower the base platform section on the tree.

2. The apparatus defined in claim 1, wherein the upper component includes at least one strap and buckle.

3. The apparatus defined in claim 1, wherein the lower component includes at least one strap and buckle.

4. The apparatus defined in claim 1, wherein the lower component is attached to the base platform section adjacent a heel of the hunter's boot, thus providing the hunter with an ability to lift with a back of the hunter's boot.

5. The apparatus defined in claim 4, wherein the upper component is adjustable to fit different sized hunter boot shafts.

6. The apparatus defined in claim 5, wherein the upper component includes a first strap, at least one buckle, and at least one strap lock that releasably engaging the at least one buckle.

7. The apparatus defined in claim 6, wherein the lower component includes a second strap, at least one additional buckle, and at least one additional strap lock that releasably engaging the at least one buckle.

8. The apparatus defined in claim 5, wherein the lower component includes a strap, at least one buckle, and at least one strap lock that releasably engaging the at least one buckle, with a portion of the strap being adapted for securement to the base platform section.

9. The apparatus defined in claim 1, wherein the lower component is attached to the base platform section rearward of a center of mass of the base platform section so that the hunter has an ability to lift with the hunter's heel while maintaining control of an angle and height of the base platform section.

10. The apparatus defined in claim 1, wherein the upper and lower components consist of straps, buckles, and strap locks that releasably engaging the buckles.

11. In a climbing tree stand including a seat-forming upper section and a base platform section that can be used to alternatingly bear weight as the other of the sections is lifted while climbing or descending a tree; an improvement comprising:
a bootstrap system having an upper component adapted to be positively secured to a hunter's boot shaft and having a lower component attached to the base platform section and to the upper component so that the hunter is tethered to the base platform section to maintain control of an angle and height of the lower section when using the hunter's boots to lift or lower the base platform section on the tree.

12. The improvement of claim 11, wherein the upper component includes at least one strap.

13. The improvement of claim 11, wherein the lower component includes at least one strap.

14. A method comprising:
providing a climbing tree stand including a seat-forming upper section and a base platform section that can be used to alternatingly bear weight as the other of the sections is lifted while climbing or descending a tree; and
securing the base platform section to a hunter's boots by a bootstrap system comprising an upper component positively secured to a hunter's boot shaft and a lower component attached to the base platform section and also to the upper component; and
climbing a tree by alternatingly bearing weight on the upper section and base platform section while the other section is lifted, with the hunter being tethered to the base platform section by the bootstrap system to positively continuously maintain control of an angle and height of the base platform section when using the hunter's boots to lift or lower the base platform section on the tree.

15. The method defined in claim 14, wherein the upper component includes at least one strap.
